(19) United States
(12) Patent Application Publication
(10) Pub. No.: US 2004/0158998 A1
(43) Pub. Date: Aug. 19, 2004

(54) Angle indicator for a ladder

(76) Inventor: Joseph Peter Scallo, Staten Island, NY (US)

Correspondence Address: Joseph P. Scallo, 56 Evans Street, Staten Island, NY, 10314, US

(21) Appl. No.: 10/770,162

(22) Filed: Feb. 3, 2004

Related U.S. Application Data
(60) Provisional application No. 60/447,516, filed on Feb. 14, 2003.

(51) Int. Cl. B23Q 17/00

(52) U.S. Cl. 33/333

(57) ABSTRACT

An angle indicator with a bubble level is provided to adjust a ladder to a predetermined position.

### CROSS-REFERENCE TO RELATED APPLICATION

This application claims priority from U.S. Provisional Patent Application No. 60/447,516, entitled “ANGLE INDICATOR FOR A LADDER,” filed Feb. 14, 2003.

### BACKGROUND

Ladders are a necessary tool for practically every home improvement, maintenance and construction job. To ensure safe operation, ladders should be positioned at a specific angle with respect to the ground and the side of the structure upon which it rests. A formula exists in the industry for determining this angle. According to the Occupational Safety & Health Administration (OSHA), for every 4 feet the ladder is raised, the bottom of the ladder should be one foot away from the structure on which it rests.

Usually, however, most who use a ladder take a best guess at the angle and position the ladder according to what feels or looks right. Many times, the angle is wrong, either too small, causing the base of the ladder to slide back, or too large, causing the ladder to tip over backwards.

### SUMMARY OF THE INVENTION

An angle indicator for a ladder comprises a bubble level constructed and arranged to indicate a predetermined angle of the ladder. The angle indicator may be removably attached to a ladder or incorporated into the manufacture of the ladder

### BRIEF DESCRIPTION OF THE DRAWINGS

FIG. 1 depicts a right triangle.

FIG. 2 shows an angle indicator according to an embodiment of the present invention.

FIG. 3 shows an alternative embodiment of the indicator of FIG. 2.

### DETAILED DESCRIPTION

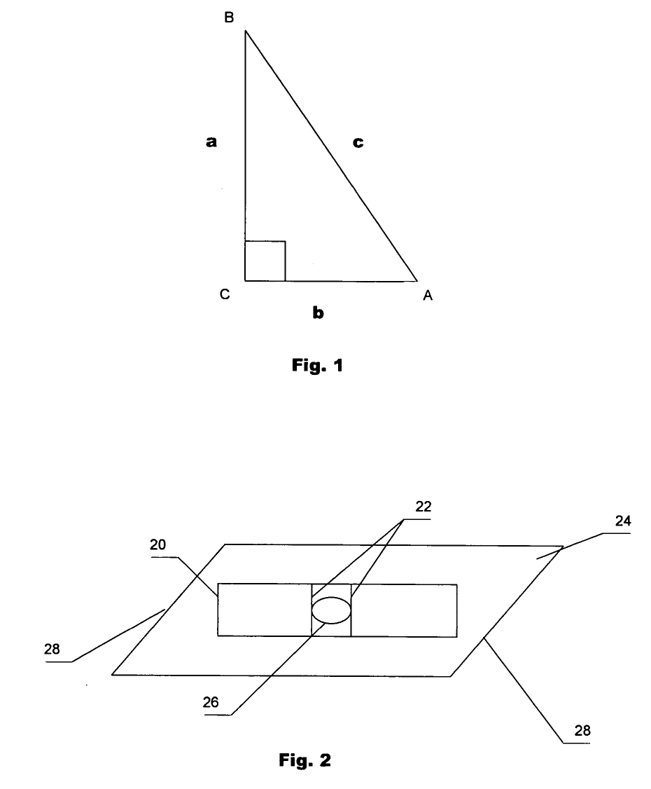

FIG. 1 shows a typical right triangle with sides a, b and c, and angles A, B, and C. The lengths of the sides and angles in the triangle may be determined by simple trigonometry. For example, The Pythagorean Theorem states that the sides of a right triangle are governed by the formula a²+b²=c². Assuming a is 4 and b is 1, the length of c is 4.1231.

Using inverse trigonometry, the angle A 10 may be determined as well. Inverse trigonometry functions arcsine, arccosine and arctangent can determine an angle from its sine, cosine, or tangent. Using the arctangent function, first the tangent of angle A is calculated, which is a/b=4/1=4. So the tan A=4. The cotangent of 4 is 75.9638 degrees, the incline of angle A.

In the case of a ladder, side c is the ladder, side b is the ground, and side a is the wall upon which the ladder rests. The ground and wall form a right angle, and in conjunction with the ladder, creates a right triangle.

In accordance with an embodiment of the present invention, a bubble level is provided that may be removably attached to a ladder or incorporated into the ladder from manufacture, that indicates the safe and proper angle for operating a ladder.

FIG. 2 shows an exemplary angle indicator. A bubble level 20 is encased in plastic 24, or any other acceptable manufacturing material that can removably attach the level 20 to a ladder (not shown). The plastic case 24 includes means for removably attaching the indicator to a ladder, such as a clip. Markings 22 on the level 20 indicate the level position for the indicator when the bubble 26 rests between the markings 22. The sides 28 may be angled so that the indicator fits into a ladder when the level 20 is in a level position.

The level 20 is positioned in the plastic 24 so that when the ladder is at a predetermined angle, preferably between 75 and 77, and most preferably at 75.9638 degrees, the bubble will indicate a level position. In this way, when the indicator is attached to a ladder, the safe operating angle is easily found by adjusting the ladder position until the bubble 26 rests between the markings 22.

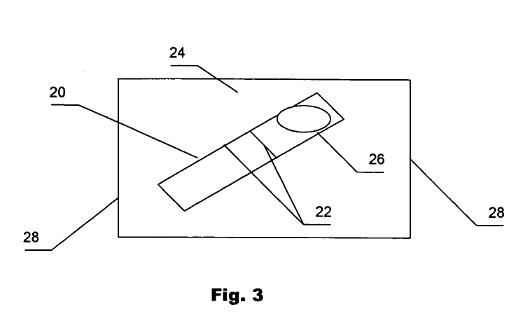

Alternatively, the case can be shaped as a square, as depicted in FIG. 3 wherein like numerals reference like elements, in which case the level is positioned at the predetermined safe operating angle relative to the bottom of the square.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. An angle indicator for a ladder comprising a bubble level constructed and arranged to indicate a predetermined angle of the ladder.

2. The angle indicator of claim 1 wherein the indicator is removably attached to the ladder.

3. The angle indicator of claim 1 wherein the predetermined angle is between approximately 75 and approximately 77 degrees.

4. The angle indicator of claim 1 wherein the predetermined angle is approximately 75.9638 degrees.

5. The angle indicator of claim 1 further comprising means for removably attaching the indicator to a ladder.

6. A ladder comprising an angle indicator having a bubble level constructed and arranged to indicate a predetermined angle of the ladder.

7. The ladder of claim 7 wherein the predetermined angle is between approximately 75 and approximately 77 degrees.

8. The ladder of claim 7 wherein the predetermined angle is approximately 75.9638 degrees.

9. The ladder of claim 7 further comprising means for removably attaching the indicator to a ladder.
